(19) United States
(12) Patent Application Publication
(10) Pub. No.: US 2015/0235214 A1
(43) Pub. Date: Aug. 20, 2015

(54) User Authentication and Authorization

(71) Applicant: BANK OF AMERICA CORPORATION, Charlotte, NC (US)

(72) Inventors: Roberta Bonsall, San Ramon, CA (US); Andrea J. Coleman, Sachse, TX (US); Mark A. Pender, Moorestown, NJ (US); Michael G. Rivers, Vacaville, CA (US)

(73) Assignee: BANK OF AMERICA CORPORATION, Charlotte, NC (US)

(21) Appl. No.: 14/184,136

(22) Filed: Feb. 19, 2014

(51) Int. Cl. G06Q 20/40; G06Q 20/38

(52) U.S. Cl. CPC G06Q 20/4012; G06Q 20/38215

(57) ABSTRACT

Systems, methods and apparatuses for authenticating a user and/or authorizing use of a reusable payment device associated with the user. In some examples, user identifying information, such as a checking account number, driver's license number, username, or the like, may be received. Based on this received information, a reusable payment device number associated with a reusable payment device of the user may be determined. This information may then be encrypted. Further, additional authenticating information may be received. For instance, a user personal identification number (PIN) may be received. The PIN may also be encrypted. The encrypted PIN and encrypted reusable payment device number may be analyzed to determine whether they are associated with the same reusable payment device. If so, a user may be authenticated.

### BACKGROUND

Maintaining the security of private or personal user information is extremely important. As the number of business transactions, user activity, and the like, being performed over potentially unsecure channels (e.g., an online or web-based application, mobile applications, traditional or cellular phone systems, and the like) increases, it is important to identify ways to ensure that the privacy of user information being provided to conduct the transactions or obtain the desired services (e.g., credit or debit card number, personal identification numbers, and the like) is maintained.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, systems and apparatuses for authenticating a user and/or authorizing use of a reusable payment device associated with the user. In some examples, user identifying information, such as a checking account number, driver's license number, username, or the like, may be received. Based on this received information, a reusable payment device number associated with a reusable payment device of the user may be determined. This information may then be encrypted. Further, additional authenticating information may be received. For instance, a user personal identification number (PIN) may be received. The PIN may also be encrypted. The encrypted PIN and encrypted reusable payment device number may be analyzed to determine whether they are associated with the same reusable payment device. If so, a user may be authenticated.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 is an illustrative block diagram of workstations and servers that may be used to implement the processes and functions of certain aspects of the present disclosure according to one or more aspects described herein.

FIG. 3 illustrates an example user authentication system according to one or more aspects described herein.

FIG. 4 is an example method authenticating a user and/or authorizing a transaction according to one or more aspects described herein.

FIGS. 5A-5D illustrate example user interfaces according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

It is noted that various connections between elements are discussed in the following description. It is noted that these connections are general and, unless specified otherwise, may be direct or indirect, wired or wireless, and that the specification is not intended to be limiting in this respect.

As will be discussed further below, aspects described herein relate to authentication of a user. In some examples, a user may initiate a request for services or a transaction. The request may be initiated via an online application, mobile application, or telephone system (e.g., telephone transaction, customer service request, or the like). In some arrangements, in order to protect the privacy of a user's personal information, it would be advantageous to not require the user to input related pieces of authenticating information to the system. For instance, if a reusable payment device (e.g., a debit card) number and associated personal identification number (PIN) are required to complete the transaction or provide the requested services, it would be advantageous to not require the user to input both pieces of information. That is, on a potentially unsecure channel, an individual intercepting the information, would not have both pieces of information if the user does not have to input both pieces of information.

Accordingly, in various examples described herein, alternate information may be used to obtain one or more pieces of information needed to complete the transaction or provide the requested services. For instance, a user may provide information identifying the user and, based on the information, a reusable payment device number may be identified (e.g., retrieved from a database) and encrypted to protect the reusable payment device number. The user may then input the PIN into the system. Accordingly, anyone intercepting the information provided by the user would only intercept the PIN and not both the PIN and reusable payment device number. The PIN may also be encrypted and a matching operation may be performed to determine whether the PIN and reusable payment device number are associated with the same reusable payment device. If so, the user may be authenticated or the reusable payment device may be authorized for user.

These and additional examples and arrangements will be discussed more fully below.

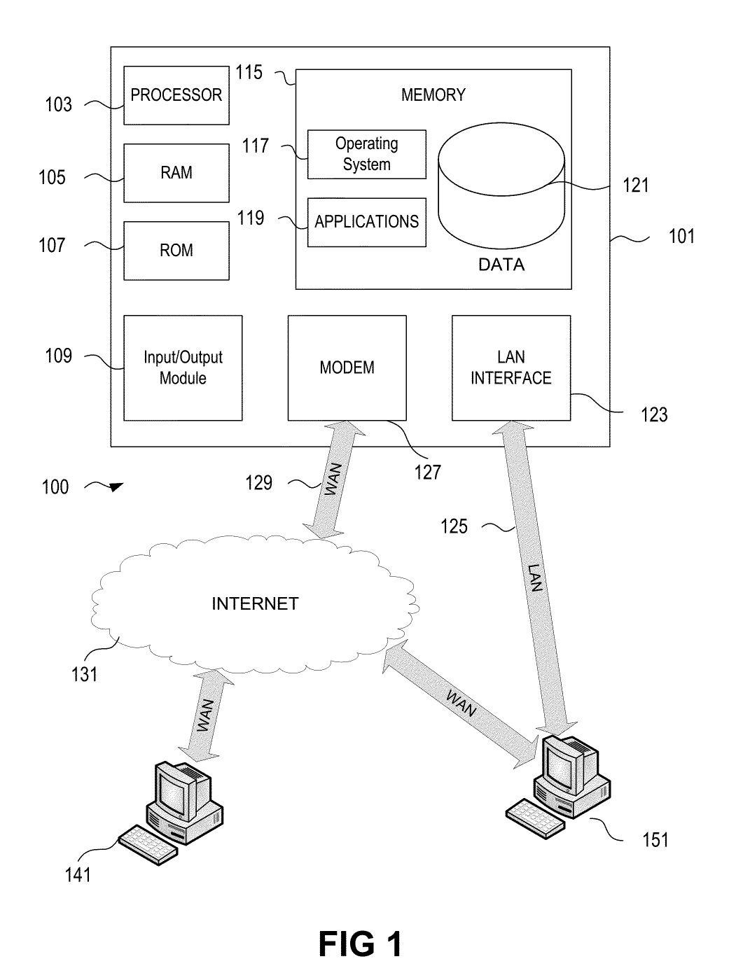

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed arrangements is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141 and 151. Computing devices 141 and 151 may be personal computing devices or servers that include any or all of the elements described above relative to computing device 101. Computing devices 141 or 151 may be a mobile device (e.g., smart phone) communicating over a wireless carrier channel.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

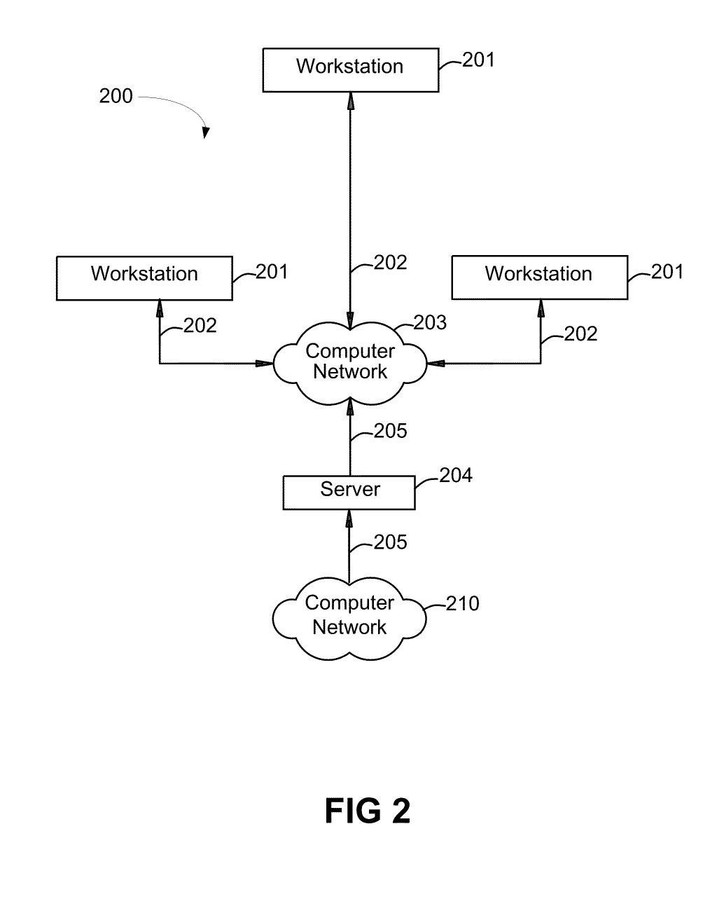

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204 (e.g. network control center), such as network links, dial-up links, wireless links, hard-wired links, as well as network types developed in the future, and the like. A virtual machine may be a software implementation of a computer that executes computer programs as if it were a standalone physical machine.

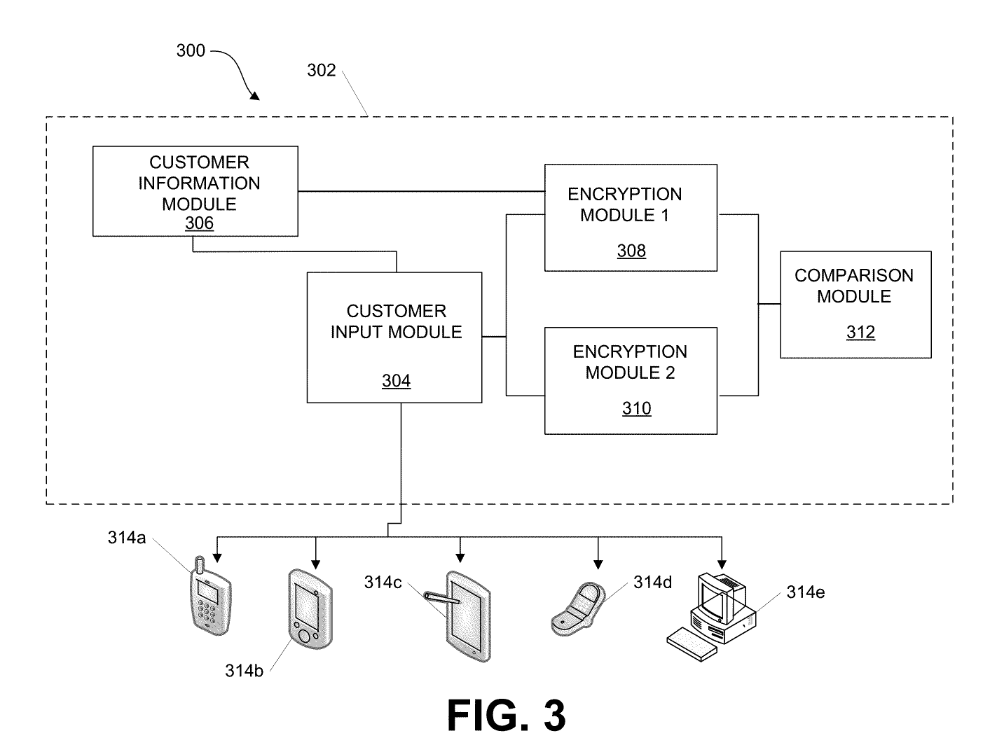

FIG. 3 illustrates one example user or customer authentication system 300 according to one or more aspects described herein. In some examples, the user authentication system 300 may be part of, internal to or associated with an entity 302. The entity 302 may be a corporation, university, government entity, and the like. In some examples, the entity 302 may be a financial institution, such as a bank. Although various aspects of the disclosure may be described in the context of a financial institution, nothing in the disclosure shall be construed as limiting the user authentication system to use within a financial institution. Rather, the system may be implemented by various other types of entities.

The user authentication system 300 may include one or more modules that may be connected to or in communication with each other, with other systems, with various computing devices, and the like. The one or more modules may include hardware and/or software configured to perform various functions within the system 300. For instance, the system 300 may include a customer or user input module 304. The customer input module 304 may be connected to or in communication with one or more user devices, such as computing devices 314a-314e. The computing devices may include a smart phone 314a, personal digital assistant (PDA) 314b, tablet computer 314c, cell phone 312d, and/or various other types of computing devices. Further, the customer input module 304 may be in communication with a plain old telephone service (POTS).

The customer input module 304 may receive user input from one or more users, customers, or potential customers, that may include transaction requests, account services requests (e.g., balance request, transfer request, and the like), purchase or payment requests (e.g., payment during a transaction being placed via a phone system or online system), and the like. In some conventional systems, a user would be required to input a number, such as a debit card number, and an associated personal identification number (PIN) to authorize the request. However, these arrangements may result in confidential or personal information being transmitted over relatively insecure channels (e.g., a telephone). Accordingly, the arrangements described herein permit a user to enter identifying information, for instance, information other than the debit card number, and the system may identify the associated debit card number based on that identifying information. That information may be encrypted and the user may then input a PIN for authentication. Accordingly, authentication of the user does not require the user to provide both the debit card number and the PIN via a potentially unsecure channel, thereby improving security, as will be discussed more fully below.

The customer input module 304 may receive a user request and may also receive one or more pieces of information provided to identify the user. For instance, a user may provide an account number, such as a checking or savings account number, a telephone number from which the user is calling (e.g., a phone number on record that matches the phone number from which the user is calling), an online or other banking identifier (e.g., a user identification used to log in to an online or mobile banking system), a driver's license number, an email address, a little known piece of information about the user (e.g., mother's maiden name, street on which the user grew up, and the like), a portion of a Social Security Number, and the like.

Upon receiving the information identifying the user, the user or customer input module 304 may retrieve additional information associated with the user from the customer information module 306. The user or customer information module 306 may include, among other hardware and/or software components, one or more databases storing information associated with a plurality of customers or users. The information may be stored, for instance, in one or more look-up tables that may include a user or customer name, address, phone number, checking account number, savings account number, driver's license number, and the like. In some examples, the customer information module 306 may further include a number for a reusable payment device, such as a debit card. For instance, the customer information module 306 may store an account number or other identifying number for the reusable payment device of one or more users.

Accordingly, upon receiving the identifying user information, the customer input module 304 may communicate with the customer information module 306 to identify an account or other number associated with the reusable payment device of the identified user. Thus, the user, who may be contacting the system via a channel with minimal security, may initiate a transaction or other action without being required to input the number of the reusable payment device into the system. That is, the number may be obtained from other identifying information provided by the user.

Once the reusable payment device number is identified, the reusable payment device number may be encrypted, such as by encryption module 1 308. In some examples, a user or transaction identifier may be generated and associated with the reusable payment device number. This associated information may then be encrypted, such as by encryption module 1 308. Accordingly, the encrypted information may be transmitted with confidence that the information is secure.

The customer input module 304 may also request additional authentication information from a user. For instance, the customer input module 304 may request a personal identification number (PIN) associated with the reusable payment device. The PIN may be a numeric or alphanumeric code provided by the user to authenticate the user during a transaction involving the reusable payment device. In this example, although the user did not input the reusable payment device number into the system 300 (e.g., via the customer input module 304) the user may be requested to input the PIN via the customer input module 304.

The PIN may then be encrypted, such as via encryption module 2 310. In some examples, the PIN may also be associated with the user or transaction identifier and the associated information may be encrypted, such as via encryption module 2 310. In some arrangements, encryption module 1 308 and encryption module 2 310 may be separate components of the system. In other examples, encryption module 1 308 and encryption module 2 may be the same component providing encryption to multiple different types of information. Further, the reusable payment device number, and any associated information, may be encrypted separately from the PIN, and any associated information, in some example arrangements. Alternatively, the data may be encrypted together or in a single encryption process.

The encrypted reusable payment device number (and user identifier or transaction identifier, if desired) may be transmitted to a comparison module 312. The encrypted PIN (and user and/or transaction identifier, as desired) also may be transmitted to the comparison module 312. The comparison module 312 may determine whether the reusable payment device number and PIN are associated with the same user, reusable payment device, and the like. In some examples, the comparison module 312 may decrypt the received encrypted information to perform the comparison. The comparison module 312 may, among other features, store customer information, such as reusable payment device numbers and associated PINs to perform the matching aspect of the system.

Upon determining that the reusable payment device number and PIN are associated with each other, the user may be considered authenticated and may proceed as desired with a transaction, account modification, or other action as desired. This authentication may be communicated to the user via one or more of the computing devices 314a-314e or via a POTS system through which the user may be accessing the customer authentication system 300.

These and various other arrangements will be discussed more fully below.

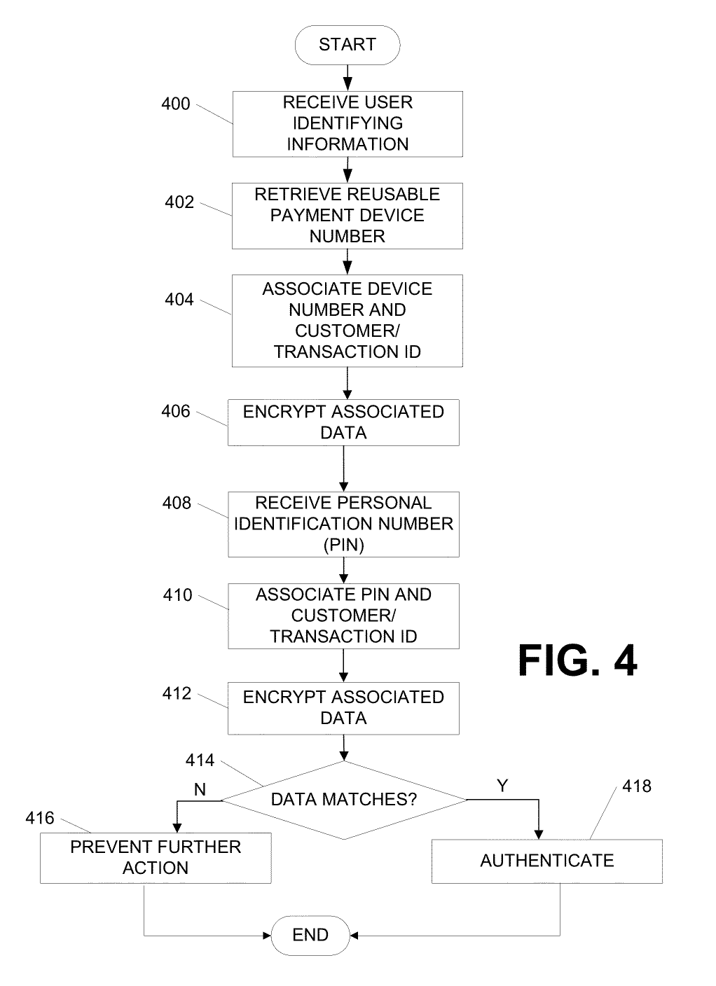

FIG. 4 illustrates one example method of authenticating a user according to one or more aspects described herein. In step 400, user identifying information may be received. The information may be received in the context of a telephone call, such as a customer service call, phone transaction, telephone based account action, and the like. Additionally or alternatively, the information may be received during an online session, such as an online banking session, or via a mobile application, such as a mobile banking application. Although various aspects described herein are described in the context of a bank or banking based application, various other entities may implement the systems and methods described herein, such as for any number of customer service functions, various types of transactions (e.g., a payment, purchase and the like), as well as various other functions. Nothing in the application should be viewed as limiting the arrangements described herein to only use in a banking environment.

The information may be received based on an initiated transaction, request for service, and the like. Accordingly, the user identifying information may include one or more of a name, username, phone number (either input by the user or determined by the system using caller identification), checking account number, savings account number, and the like. The user identifying information may be used to determine an identity of the user.

Based upon the received information, a reusable payment device number may be identified in step 402. The reusable payment device may be, in some examples, a debit card associated with the identified user. The reusable payment device number may be retrieved from one or more data stores in communication with the system. In some examples, the user input received from the user or customer does not include the reusable payment device number.

Optionally, in step 404, a user or transaction identifier may be generated by the system and may be associated with the identified reusable payment device number. For instance, each transaction may be labeled with a unique identifier that may be numeric, alphanumeric, and the like. Alternatively, upon receiving the user identifying information, a user identifier may be generated for that particular user. In some examples, the user/transaction identifier may be associated with the reusable payment device number. The reusable payment device number (and, optionally, the transaction identifier and/or user identifier) may be encrypted in step 406. The information may be encrypted using various known methods of encryption.

In step 408, the system may receive a PIN of the user associated with the reusable payment device. In some examples, the user may be prompted to input the PIN. The PIN may be a numeric or alphanumeric code used to authenticate a user of the reusable payment device or authorize use of the reusable payment device during a transaction. Optionally, in step 410, the received PIN may be associated with the transaction identifier or user identifier generated in step 404. In step 412, the PIN (and, optionally, transaction and/or user identifier) may be encrypted.

The encrypted data from step 406 may be compared with the encrypted data from step 412 to determine whether the received PIN is associated with the reusable payment device number. In some arrangements, the encrypted data may be transmitted to a device, system, server, portion of the system, or the like, to analyze the encrypted data. For instance, the encrypted data may be transmitted to a back office system, computing device, server, or portion of the system, for analysis to determine whether the PIN is associated with the reusable payment device number. Additionally or alternatively, the encrypted data may be decrypted in order to perform a comparison to determine whether the PIN is associated with the reusable payment device number.

In step 414, a determination is made as to whether the PIN is associated with the reusable payment device number. If so, the user is authenticated in step 418 and may proceed with the desired service, transaction or the like. If, in step 414, it is determined that the PIN and reusable payment device number are not associated, the user will be prevented for continuing with any requested service, transaction, or the like, in step 416.

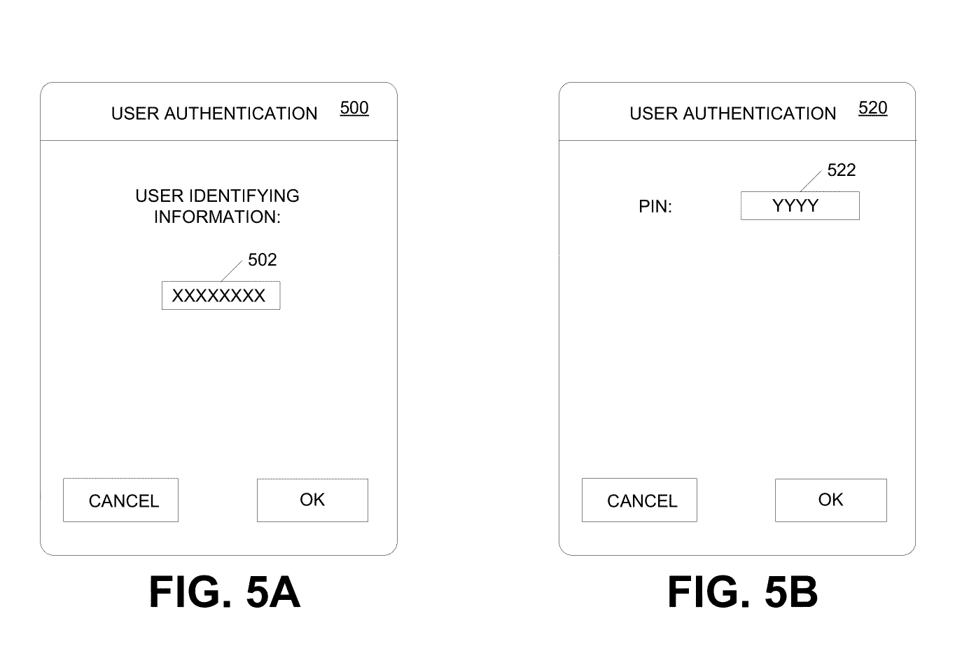

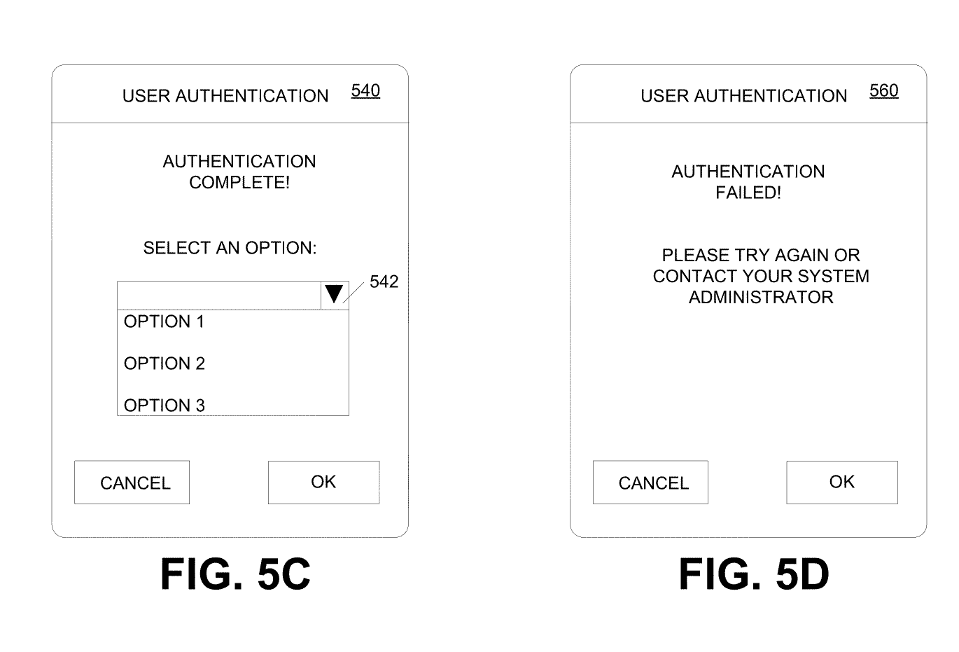

FIGS. 5A-5D illustrate various example user interfaces that may be provided to a user accessing the system via an online or mobile environment. The user interface provided are merely some example user interfaces and various other interfaces or options within each interface may be provided without departing from the invention.

FIG. 5A illustrates one example user interface to authenticate a user. The interface 500 includes field 502 in which a user may insert a username or other identifying information. The username may be, for instance, an online application username generally used to login to an application. In some examples, the username may be provided again, after an initial login into a system, in order to determine additional information about the user. Alternatively, other identifying information may be provided in field 502, such as a phone number of the user, checking account number, driver's license number, or the like.

Upon receipt of the user identifying information, the user may be identified and a reusable payment device number for the user may be identified. As discussed above, a user or transaction identifier may be associated with the reusable payment device number and the associated information may be encrypted. The user may then be prompted for additional information, as in FIG. 5B.

FIG. 5B illustrates a user interface 520 requesting additional information from the user. Field 522 is requesting a PIN number of the user. The user may input the requested information may be select “OK” option to proceed. The system may then associate the PIN with the customer or transaction identifier, as discussed above, and encrypt the associated information.

A matching process may take place, as discussed above and, upon determining that the PIN and reusable payment device number are associated, the user may be authenticated to the system and may proceed with desired services, transactions, or the like. FIG. 5C illustrates one example interface 540 in which a user has been authenticated. The user may then select one or more options from a list of options shown in field 542.

Alternatively, if the PIN and reusable payment device are not associated, an interface such as interface 560 in FIG. 5D may be provided to the user. The interface may indicate that the authentication process was not successful and may request the user to attempt the authentication process again or request assistance.

As discussed above, permitting a user to authenticate or authorize use of a reusable payment device without providing multiple, related pieces of authenticating information provides additional security to the personal information of the user. For instance, the arrangements described herein permit a user to enter confidential or private information into an unsecure or potentially unsecure channel while reducing the risk of unauthorized activity because the confidential information provided (e.g., a PIN) cannot be associated with additional confidential information (e.g., a reusable payment device number) that may be needed to perpetuate the unauthorized access.

Further, encrypting the data separately may also provide additional security to the information that may be transmitted via potentially unsecure channels.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Further, one or more aspects described with respect to one figure or arrangement may be used in conjunction with other aspects associated with another figure or portion of the description.

What is claimed is:

1. An apparatus, comprising:
at least one processor; and
a memory storing computer-readable instructions that, when executed by the at least one processor, cause the apparatus to:
receive information identifying a user;
determine, based on the received information identifying the user, a reusable payment device number of a reusable payment device associated with the user;
encrypt the reusable payment device number;
receive additional information to authenticate the user;
encrypt the additional information;
analyze the encrypted reusable payment device number and the encrypted additional information to determine whether the reusable payment device number and the additional information are associated with the same reusable payment device; and
responsive to determining that the reusable payment device number and additional information are associated with the same reusable payment device, authenticate the user.

2. The apparatus of claim 1, further including instructions that, when executed, cause the apparatus to:
generate at least one of: a transaction identifier and a user identifier;
associate the at least one of the transaction identifier and the user identifier with the reusable payment device number;
encrypt the associated at least one of the transaction identifier and user identifier with the reusable payment device number;
associate the at least of the transaction identifier and the user identifier with the additional information;
encrypt the associated at least one of the transaction identifier and user identifier with the additional information;
wherein the step of analyzing further includes analyzing the encrypted associated at least one of the transaction identifier and user identifier and the reusable payment device number, and the encrypted at least one of the transaction identifier and user identifier and the additional information to determine whether the reusable payment device number and the additional information are associated with the same reusable payment device; and
responsive to determining that the reusable payment device number and additional information are associated with the same reusable payment device, authenticate the user.

3. The apparatus of claim 1, wherein the additional information includes a personal identification number (PIN) of the user.

4. The apparatus of claim 1, wherein analyzing the encrypted reusable payment device number and the encrypted additional information to determine whether the reusable payment device number and the additional information are associated with the same reusable payment device further includes decrypting the encrypted reusable payment device number and the encrypted additional information.

5. The apparatus of claim 1, wherein the received information identifying the user includes at least one of: a checking account number, a savings account number, a username of the user, a telephone number of the user, and a driver's license number of the user.

6. The apparatus of claim 1, wherein determining the reusable payment device number includes retrieving the reusable payment device number from a database linking the reusable payment device number with the information identifying the user.

7. The apparatus of claim 1, wherein the received information identifying the user does not include the reusable payment device number.

8. The apparatus of claim 1, wherein the reusable payment device is a debit card of the user.

9. The apparatus of claim 1, further including, instructions that, when executed, cause the apparatus to:
responsive to authenticating the user, provide access to one or more options to the user; and
responsive to determining that the reusable payment device number and additional information are not associated with the same reusable payment device, providing a notification to the user that authentication was unsuccessful.

10. A method, comprising:
receiving, by a user authentication system having at least one processor, information identifying a user;
determining, by the user authentication system and based on the received information identifying the user, a reusable payment device number of a reusable payment device associated with the user;
encrypting, by the user authentication system, the reusable payment device number;
receiving, by the user authentication system, additional information to authenticate the user;
encrypting, by the user authentication system, the additional information;
analyzing, by the user authentication system, the encrypted reusable payment device number and the encrypted additional information to determine whether the reusable payment device number and the additional information are associated with the same reusable payment device; and
responsive to determining that the reusable payment device number and additional information are associated with the same reusable payment device, authenticating the user.

11. The method of claim 10, further including:
generating, by the user authentication system, at least one of: a transaction identifier and a user identifier;
associating, by the user authentication system, the at least one of the transaction identifier and the user identifier with the reusable payment device number;
encrypting, by the user authentication system, the associated at least one of the transaction identifier and user identifier with the reusable payment device number;
associating, by the user authentication system, the at least of the transaction identifier and the user identifier with the additional information;
encrypting, by the user authentication system, the associated at least one of the transaction identifier and user identifier with the additional information;
wherein the step of analyzing further includes analyzing the encrypted associated at least one of the transaction identifier and user identifier and the reusable payment device number, and the encrypted at least one of the transaction identifier and user identifier and the additional information to determine whether the reusable payment device number and the additional information are associated with the same reusable payment device; and
responsive to determining that the reusable payment device number and additional information are associated with the same reusable payment device, authenticating the user.

12. The method of claim 10, wherein the additional information includes a personal identification number (PIN) of the user.

13. The method of claim 10, wherein analyzing the encrypted reusable payment device number and the encrypted additional information to determine whether the reusable payment device number and the additional information are associated with the same reusable payment device further includes decrypting the encrypted reusable payment device number and the encrypted additional information.

14. The method of claim 10, wherein the received information identifying the user includes at least one of: a checking account number, a savings account number, a username of the user, a telephone number of the user, and a driver's license number of the user.

15. The method of claim 10, wherein the received information identifying the user does not include the reusable payment device number.

16. One or more non-transitory computer-readable media having computer-executable instructions stored thereon that, when executed, cause at least one computing device to:
receive information identifying a user;
determine, based on the received information identifying the user, a reusable payment device number of a reusable payment device associated with the user;
encrypt the reusable payment device number;
receive additional information to authenticate the user;
encrypt the additional information;
analyze the encrypted reusable payment device number and the encrypted additional information to determine whether the reusable payment device number and the additional information are associated with the same reusable payment device; and
responsive to determining that the reusable payment device number and additional information are associated with the same reusable payment device, authenticate the user.

17. The one or more non-transitory computer-readable media of claim 16, further including instructions that, when executed, cause the at least one computing device to:
generate at least one of: a transaction identifier and a user identifier;
associate the at least one of the transaction identifier and the user identifier with the reusable payment device number;
encrypt the associated at least one of the transaction identifier and user identifier with the reusable payment device number;
associate the at least of the transaction identifier and the user identifier with the additional information;
encrypt the associated at least one of the transaction identifier and user identifier with the additional information;
wherein the step of analyzing further includes analyzing the encrypted associated at least one of the transaction identifier and user identifier and the reusable payment device number, and the encrypted at least one of the transaction identifier and user identifier and the additional information to determine whether the reusable payment device number and the additional information are associated with the same reusable payment device; and
responsive to determining that the reusable payment device number and additional information are associated with the same reusable payment device, authenticate the user.

18. The one or more non-transitory computer-readable media of claim 16, wherein the additional information includes a personal identification number (PIN) of the user.

19. The one or more non-transitory computer-readable media of claim 16, wherein analyzing the encrypted reusable payment device number and the encrypted additional information to determine whether the reusable payment device number and the additional information are associated with the same reusable payment device further includes decrypting the encrypted reusable payment device number and the encrypted additional information.

20. The one or more non-transitory computer-readable media of claim 16, wherein the received information identifying the user does not include the reusable payment device number.
